(19) United States
(12) Patent Application Publication
(10) Pub. No.: US 2024/0289791 A1
(43) Pub. Date: Aug. 29, 2024

(54) Method, System, and Computer Program Product for Linking Latent Related Payment Devices

(71) Applicant: Visa International Service Association, San Francisco, CA (US)

(72) Inventors: Atindra Nath Ghosh, Singapore (SG); Venkatesh Sankarakumar, Singapore (SG)

(21) Appl. No.: 18/114,454

(22) Filed: Feb. 27, 2023

(51) Int. Cl. G06Q 20/40; G06Q 20/38

(52) U.S. Cl. CPC G06Q 20/401; G06Q 20/389

(57) ABSTRACT

A method includes: receiving a linking request from a first user device, the linking request identifying a first payment device of a first user and a second payment device of a second user, where the first payment device and the second payment device are not linked by an issuer system; retrieving contact data of a second user device of the second user based on the second payment device; authorizing the linking request by: transmitting a confirmation request to the second user device; and receiving a confirmation response; generating a linking identifier; storing the first payment device and the second payment device in a database in association with the linking identifier; receiving a transaction request for a transaction, the transaction request identifying the first or second payment device; and invoking a linking protocol by storing transaction data associated with the transaction in the database in association with the linking identifier.

### BACKGROUND

### 1. Field

This disclosure relates generally to linking payment devices and, in non-limiting embodiments or aspects, to methods, systems, and computer program products for linking latent related payment devices.

### 2. Technical Considerations

Individuals associating with a group may hold separate individual payment devices not linked to payment devices held by other individuals within the same group. Examples of groups include families having a plurality of family members, groups of friends, businesses having a plurality of business associates, organizations having a plurality of members, and the like. Because certain payment devices held individually by each member of a group are not linked, such as linked by an issuer system where the association is stored by a database thereof, it is difficult to monitor patterns of the group from those disparate, unlinked payment devices and gain insights from those patterns. For example, it may be difficult to identify payment devices that should be linked as a group (given the latent nature of the potential relationship between unlinked payment devices) and subsequently generate composite reports reflecting the transaction activity of the group. No solutions presently exist to integrate separate, unlinked payment devices having this latent relationship of being associated with the same group.

### SUMMARY

According to non-limiting embodiments or aspects, provided is a computer-implemented method that includes: receiving, with a transaction processing server, a linking request from a first user device of a first user, the linking request identifying a first payment device of the first user and at least one second payment device of at least one second user, where the first payment device and the at least one second payment device are not linked by an issuer system of the first payment device or the at least one second payment device; in response to receiving the linking request, retrieving, with the transaction processing server, contact data of at least one second user device of the at least one second user based on the at least one second payment device; authorizing, with the transaction processing server, the linking request by: transmitting, using the retrieved contact data, a confirmation request to the at least one second user device; and receiving, from the at least one second user device, a confirmation response including a data field containing an indicator based on approving the confirmation request; in response to receiving the confirmation response containing the indicator, generating, with the transaction processing server, a linking identifier; storing, with the transaction processing server, the first payment device and the at least one second payment device in a database in association with the linking identifier; receiving, with the transaction processing server, a transaction request for a payment transaction, the transaction request identifying at least one of the first payment device and the at least one second payment device; and in response to determining that the transaction request identifies at least one of the first payment device and the at least one second payment device, invoking, with the transaction processing server, a linking protocol by storing transaction data associated with processing the payment transaction in the database in association with the linking identifier.

In non-limiting embodiments or aspects, the first payment device may be associated with a first account number, and the at least one second payment device may be associated with at least one second account number different from the first account number.

In non-limiting embodiments or aspects, the first payment device may be issued by a first issuer system, and the at least one second payment device may be issued by at least one second issuer system different from the first issuer system.

In non-limiting embodiments or aspects, the computer-implemented method may further include: in response to determining that the transaction request identifies at least one of the first payment device and the at least one second payment device, retrieving, with the transaction processing server, the linking identifier; generating, with the transaction processing server, an authorization request including data fields containing transaction data associated with the payment transaction and the linking identifier; and transmitting, with the transaction processing server, the authorization request to the issuer system of the first payment device or the at least one second payment device to cause the issuer system to generate an authorization decision.

In non-limiting embodiments or aspects, the linking identifier may be retrieved in real time relative to receiving the transaction request.

In non-limiting embodiments or aspects, a first plurality of payment transactions may be initiated with the first payment device and a second plurality of payment transactions may be initiated with the at least one second payment device, the computer-implemented method may further include: invoking, with the transaction processing server, the linking protocol by storing transaction data associated with the first plurality of payment transactions and the second plurality of payment transactions in the database in association with the linking identifier; and generating, with the transaction processing server, a composite report combining transaction activity of the first payment device and the at least one second payment device associated with the linking identifier based on the transaction data associated with the first plurality of payment transactions and the second plurality of payment transactions.

In non-limiting embodiments or aspects, the composite report may be generated in response to receiving a report request from at least one of the first user device and the at least one second user device; and the composite report may be displayed on the at least one of the first user device and the at least one second user device in response to receiving the report request.

In non-limiting embodiments or aspects, a first plurality of payment transactions may be initiated with the first payment device and a second plurality of payment transactions may be initiated with the at least one second payment device, the computer-implemented method may further include: invoking, with the transaction processing server, the linking protocol by storing transaction data associated with the first plurality of payment transactions and the second plurality of payment transactions in the database in association with the linking identifier; inputting, with the transaction processing server, the transaction data associated with the first plurality of payment transactions and the second plurality of payment transactions into a machine learning algorithm; and generating, with the machine learning algorithm, a composite output combining transaction activity of the first payment device and the at least one second payment device based on the transaction data associated with the first plurality of payment transactions and the second plurality of payment transactions.

In non-limiting embodiments or aspects, the machine learning algorithm may include a clustering algorithm, where generating the composite output may include the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

In non-limiting embodiments or aspects, each object may include a payment transaction of the first plurality of payment transactions and the second plurality of payment transactions, where the vector may be generated for each payment transaction based on multi-variable transaction data corresponding to each payment transaction.

In non-limiting embodiments or aspects, the computer-implemented method may further include: generating at least one offer associated with the linking identifier based on at least one cluster of the plurality of clusters; and transmitting an offer message containing the at least one offer to at least one of the first user device and the at least one second user device.

According to non-limiting embodiments or aspects, provided is a system including at least one transaction processing server, programmed or configured to: receive a linking request from a first user device of a first user, the linking request identifying a first payment device of the first user and at least one second payment device of at least one second user, where the first payment device and the at least one second payment device are not linked by an issuer system of the first payment device or the at least one second payment device; in response to receiving the linking request, retrieve contact data of at least one second user device of the at least one second user based on the at least one second payment device; authorize the linking request by: transmitting, using the retrieved contact data, a confirmation request to the at least one second user device; and receiving, from the at least one second user device, a confirmation response including a data field containing an indicator based on approving the confirmation request; in response to receiving the confirmation response containing the indicator, generate a linking identifier; store the first payment device and the at least one second payment device in a database in association with the linking identifier; receive a transaction request for a payment transaction, the transaction request identifying at least one of the first payment device and the at least one second payment device; and in response to determining that the transaction request identifies at least one of the first payment device and the at least one second payment device, invoke a linking protocol by storing transaction data associated with processing the payment transaction in the database in association with the linking identifier.

In non-limiting embodiments or aspects, the first payment device may be associated with a first account number, and the at least one second payment device may be associated with at least one second account number different from the first account number.

In non-limiting embodiments or aspects, the first payment device may be issued by a first issuer system, and the at least one second payment device may be issued by at least one second issuer system different from the first issuer system.

In non-limiting embodiments or aspects, the at least one transaction processing server may be further programmed or configured to: in response to determining that the transaction request identifies at least one of the first payment device and the at least one second payment device, retrieve the linking identifier; generate an authorization request including data fields containing transaction data associated with the payment transaction and the linking identifier; and transmit the authorization request to the issuer system of the first payment device or the at least one second payment device to cause the issuer system to generate an authorization decision.

In non-limiting embodiments or aspects, the linking identifier may be retrieved in real time relative to receiving the transaction request.

In non-limiting embodiments or aspects, a first plurality of payment transactions may be initiated with the first payment device and a second plurality of payment transactions may be initiated with the at least one second payment device, where the at least one transaction processing server may be further programmed or configured to: invoke the linking protocol by storing transaction data associated with the first plurality of payment transactions and the second plurality of payment transactions in the database in association with the linking identifier; and generate a composite report combining transaction activity of the first payment device and the at least one second payment device associated with the linking identifier based on the transaction data associated with the first plurality of payment transactions and the second plurality of payment transactions.

In non-limiting embodiments or aspects, the composite report may be generated in response to receiving a report request from at least one of the first user device and the at least one second user device; and the composite report may be displayed on the at least one of the first user device and the at least one second user device in response to receiving the report request.

In non-limiting embodiments or aspects, a first plurality of payment transactions may be initiated with the first payment device and a second plurality of payment transactions may be initiated with the at least one second payment device, where the at least one transaction processing server may be further programmed or configured to: invoke the linking protocol by storing transaction data associated with the first plurality of payment transactions and the second plurality of payment transactions in the database in association with the linking identifier; and input the transaction data associated with the first plurality of payment transactions and the second plurality of payment transactions into a machine learning algorithm, where the system may include the machine learning algorithm programmed or configured to generate a composite output combining transaction activity of the first payment device and the at least one second payment device based on the transaction data associated with the first plurality of payment transactions and the second plurality of payment transactions.

In non-limiting embodiments or aspects, the machine learning algorithm may include a clustering algorithm, where generating the composite output may include the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

In non-limiting embodiments or aspects, each object may include a payment transaction of the first plurality of payment transactions and the second plurality of payment transactions, where the vector may be generated for each payment transaction based on multi-variable transaction data corresponding to each payment transaction.

In non-limiting embodiments or aspects, at least one processor may be further programmed or configured to: generate at least one offer associated with the linking identifier based on at least one cluster of the plurality of clusters; and transmit an offer message containing the at least one offer to at least one of the first user device and the at least one second user device.

According to non-limiting embodiments or aspects, provided is a computer program product including at least one non-transitory computer-readable medium including program instructions that, when executed by at least one transaction processing server, cause the at least one transaction processing server to: receive a linking request from a first user device of a first user, the linking request identifying a first payment device of the first user and at least one second payment device of at least one second user, where the first payment device and the at least one second payment device are not linked by an issuer system of the first payment device or the at least one second payment device; in response to receiving the linking request, retrieve contact data of at least one second user device of the at least one second user based on the at least one second payment device; authorize the linking request by: transmitting, using the retrieved contact data, a confirmation request to the at least one second user device; and receiving, from the at least one second user device, a confirmation response including a data field containing an indicator based on approving the confirmation request; in response to receiving the confirmation response containing the indicator, generate a linking identifier; store the first payment device and the at least one second payment device in a database in association with the linking identifier; receive a transaction request for a payment transaction, the transaction request identifying at least one of the first payment device and the at least one second payment device; and in response to determining that the transaction request identifies at least one of the first payment device and the at least one second payment device, invoke a linking protocol by storing transaction data associated with processing the payment transaction in the database in association with the linking identifier.

In non-limiting embodiments or aspects, the first payment device may be associated with a first account number, and the at least one second payment device may be associated with at least one second account number different from the first account number.

In non-limiting embodiments or aspects, the first payment device may be issued by a first issuer system, and the at least one second payment device may be issued by at least one second issuer system different from the first issuer system.

In non-limiting embodiments or aspects, the program instructions may further cause the at least one transaction processing server to: in response to determining that the transaction request identifies at least one of the first payment device and the at least one second payment device, retrieve the linking identifier; generate an authorization request including data fields containing transaction data associated with the payment transaction and the linking identifier; and transmit the authorization request to the issuer system of the first payment device or the at least one second payment device to cause the issuer system to generate an authorization decision.

In non-limiting embodiments or aspects, the linking identifier may be retrieved in real time relative to receiving the transaction request.

In non-limiting embodiments or aspects, a first plurality of payment transactions may be initiated with the first payment device and a second plurality of payment transactions may be initiated with the at least one second payment device, where the program instructions may further cause the at least one transaction processing server to: invoke the linking protocol by storing transaction data associated with the first plurality of payment transactions and the second plurality of payment transactions in the database in association with the linking identifier; and generate a composite report combining transaction activity of the first payment device and the at least one second payment device associated with the linking identifier based on the transaction data associated with the first plurality of payment transactions and the second plurality of payment transactions.

In non-limiting embodiments or aspects, the composite report may be generated in response to receiving a report request from at least one of the first user device and the at least one second user device; and the composite report may be displayed on the at least one of the first user device and the at least one second user device in response to receiving the report request.

In non-limiting embodiments or aspects, a first plurality of payment transactions may be initiated with the first payment device and a second plurality of payment transactions may be initiated with the at least one second payment device, where the program instructions may further cause the at least one transaction processing server to: invoke the linking protocol by storing transaction data associated with the first plurality of payment transactions and the second plurality of payment transactions in the database in association with the linking identifier; and input the transaction data associated with the first plurality of payment transactions and the second plurality of payment transactions into a machine learning algorithm, where the program instructions may cause the machine learning algorithm to generate a composite output combining transaction activity of the first payment device and the at least one second payment device based on the transaction data associated with the first plurality of payment transactions and the second plurality of payment transactions.

In non-limiting embodiments or aspects, the machine learning algorithm may include a clustering algorithm, where generating the composite output may include the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

In non-limiting embodiments or aspects, each object may include a payment transaction of the first plurality of payment transactions and the second plurality of payment transactions, where the vector may be generated for each payment transaction based on multi-variable transaction data corresponding to each payment transaction.

In non-limiting embodiments or aspects, the program instructions may further cause at least one processor to: generate at least one offer associated with the linking identifier based on at least one cluster of the plurality of clusters; and transmit an offer message containing the at least one offer to at least one of the first user device and the at least one second user device.

Other non-limiting embodiments or aspects will be set forth in the following numbered clauses:

Clause 1: A computer-implemented method comprising: receiving, with a transaction processing server, a linking request from a first user device of a first user, the linking request identifying a first payment device of the first user and at least one second payment device of at least one second user, wherein the first payment device and the at least one second payment device are not linked by an issuer system of the first payment device or the at least one second payment device; in response to receiving the linking request, retrieving, with the transaction processing server, contact data of at least one second user device of the at least one second user based on the at least one second payment device; authorizing, with the transaction processing server, the linking request by: transmitting, using the retrieved contact data, a confirmation request to the at least one second user device; and receiving, from the at least one second user device, a confirmation response comprising a data field containing an indicator based on approving the confirmation request; in response to receiving the confirmation response containing the indicator, generating, with the transaction processing server, a linking identifier; storing, with the transaction processing server, the first payment device and the at least one second payment device in a database in association with the linking identifier; receiving, with the transaction processing server, a transaction request for a payment transaction, the transaction request identifying at least one of the first payment device and the at least one second payment device; and in response to determining that the transaction request identifies at least one of the first payment device and the at least one second payment device, invoking, with the transaction processing server, a linking protocol by storing transaction data associated with processing the payment transaction in the database in association with the linking identifier.

Clause 2: The computer-implemented method of clause 1, wherein the first payment device is associated with a first account number, and the at least one second payment device is associated with at least one second account number different from the first account number.

Clause 3: The computer-implemented method of clause 1 or 2, wherein the first payment device is issued by a first issuer system, and the at least one second payment device is issued by at least one second issuer system different from the first issuer system.

Clause 4: The computer-implemented method of any of clauses 1-3, further comprising: in response to determining that the transaction request identifies at least one of the first payment device and the at least one second payment device, retrieving, with the transaction processing server, the linking identifier; generating, with the transaction processing server, an authorization request comprising data fields containing transaction data associated with the payment transaction and the linking identifier; and transmitting, with the transaction processing server, the authorization request to the issuer system of the first payment device or the at least one second payment device to cause the issuer system to generate an authorization decision.

Clause 5: The computer-implemented method of any of clauses 1-4, wherein the linking identifier is retrieved in real time relative to receiving the transaction request.

Clause 6: The computer-implemented method of any of clauses 1-5, comprising a first plurality of payment transactions initiated with the first payment device and a second plurality of payment transactions initiated with the at least one second payment device, the computer-implemented method further comprising: invoking, with the transaction processing server, the linking protocol by storing transaction data associated with the first plurality of payment transactions and the second plurality of payment transactions in the database in association with the linking identifier; and generating, with the transaction processing server, a composite report combining transaction activity of the first payment device and the at least one second payment device associated with the linking identifier based on the transaction data associated with the first plurality of payment transactions and the second plurality of payment transactions.

Clause 7: The computer-implemented method of any of clauses 1-6, wherein the composite report is generated in response to receiving a report request from at least one of the first user device and the at least one second user device; and the composite report is displayed on the at least one of the first user device and the at least one second user device in response to receiving the report request.

Clause 8: The computer-implemented method of any of clauses 1-7, comprising a first plurality of payment transactions initiated with the first payment device and a second plurality of payment transactions initiated with the at least one second payment device, the computer-implemented method further comprising: invoking, with the transaction processing server, the linking protocol by storing transaction data associated with the first plurality of payment transactions and the second plurality of payment transactions in the database in association with the linking identifier; inputting, with the transaction processing server, the transaction data associated with the first plurality of payment transactions and the second plurality of payment transactions into a machine learning algorithm; and generating, with the machine learning algorithm, a composite output combining transaction activity of the first payment device and the at least one second payment device based on the transaction data associated with the first plurality of payment transactions and the second plurality of payment transactions.

Clause 9: The computer-implemented method of any of clauses 1-8, wherein the machine learning algorithm comprises a clustering algorithm, wherein generating the composite output comprises the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

Clause 10: The computer-implemented method of any of clauses 1-9, wherein each object comprises a payment transaction of the first plurality of payment transactions and the second plurality of payment transactions, wherein the vector is generated for each payment transaction based on multi-variable transaction data corresponding to each payment transaction.

Clause 11: The computer-implemented method of any of clauses 1-10, further comprising: generating at least one offer associated with the linking identifier based on at least one cluster of the plurality of clusters; and transmitting an offer message containing the at least one offer to at least one of the first user device and the at least one second user device.

Clause 12: A system comprising at least one transaction processing server, programmed or configured to: receive a linking request from a first user device of a first user, the linking request identifying a first payment device of the first user and at least one second payment device of at least one second user, wherein the first payment device and the at least one second payment device are not linked by an issuer system of the first payment device or the at least one second payment device; in response to receiving the linking request, retrieve contact data of at least one second user device of the at least one second user based on the at least one second payment device; authorize the linking request by: transmitting, using the retrieved contact data, a confirmation request to the at least one second user device; and receiving, from the at least one second user device, a confirmation response comprising a data field containing an indicator based on approving the confirmation request; in response to receiving the confirmation response containing the indicator, generate a linking identifier; store the first payment device and the at least one second payment device in a database in association with the linking identifier; receive a transaction request for a payment transaction, the transaction request identifying at least one of the first payment device and the at least one second payment device; and in response to determining that the transaction request identifies at least one of the first payment device and the at least one second payment device, invoke a linking protocol by storing transaction data associated with processing the payment transaction in the database in association with the linking identifier.

Clause 13: The system of clause 12, wherein the first payment device is associated with a first account number, and the at least one second payment device is associated with at least one second account number different from the first account number.

Clause 14: The system of clause 12 or 13, wherein the first payment device is issued by a first issuer system, and the at least one second payment device is issued by at least one second issuer system different from the first issuer system.

Clause 15: The system of any of clauses 12-14, wherein the at least one transaction processing server is further programmed or configured to: in response to determining that the transaction request identifies at least one of the first payment device and the at least one second payment device, retrieve the linking identifier; generate an authorization request comprising data fields containing transaction data associated with the payment transaction and the linking identifier; and transmit the authorization request to the issuer system of the first payment device or the at least one second payment device to cause the issuer system to generate an authorization decision.

Clause 16: The system of any of clauses 12-15, wherein the linking identifier is retrieved in real time relative to receiving the transaction request.

Clause 17: The system of any of clauses 12-16, comprising a first plurality of payment transactions initiated with the first payment device and a second plurality of payment transactions initiated with the at least one second payment device, wherein the at least one transaction processing server is further programmed or configured to: invoke the linking protocol by storing transaction data associated with the first plurality of payment transactions and the second plurality of payment transactions in the database in association with the linking identifier; and generate a composite report combining transaction activity of the first payment device and the at least one second payment device associated with the linking identifier based on the transaction data associated with the first plurality of payment transactions and the second plurality of payment transactions.

Clause 18: The system of any of clauses 12-17, wherein the composite report is generated in response to receiving a report request from at least one of the first user device and the at least one second user device; and the composite report is displayed on the at least one of the first user device and the at least one second user device in response to receiving the report request.

Clause 19: The system of any of clauses 12-18, comprising a first plurality of payment transactions initiated with the first payment device and a second plurality of payment transactions initiated with the at least one second payment device, wherein the at least one transaction processing server is further programmed or configured to: invoke the linking protocol by storing transaction data associated with the first plurality of payment transactions and the second plurality of payment transactions in the database in association with the linking identifier; and input the transaction data associated with the first plurality of payment transactions and the second plurality of payment transactions into a machine learning algorithm, wherein the system comprises the machine learning algorithm programmed or configured to generate a composite output combining transaction activity of the first payment device and the at least one second payment device based on the transaction data associated with the first plurality of payment transactions and the second plurality of payment transactions.

Clause 20: The system of any of clauses 12-19, wherein the machine learning algorithm comprises a clustering algorithm, wherein generating the composite output comprises the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

Clause 21: The system of any of clauses 12-20, wherein each object comprises a payment transaction of the first plurality of payment transactions and the second plurality of payment transactions, wherein the vector is generated for each payment transaction based on multi-variable transaction data corresponding to each payment transaction.

Clause 22: The system of any of clauses 12-21, comprising at least one processor further programmed or configured to: generate at least one offer associated with the linking identifier based on at least one cluster of the plurality of clusters; and transmit an offer message containing the at least one offer to at least one of the first user device and the at least one second user device.

Clause 23: A computer program product comprising at least one non-transitory computer-readable medium including program instructions that, when executed by at least one transaction processing server, cause the at least one transaction processing server to: receive a linking request from a first user device of a first user, the linking request identifying a first payment device of the first user and at least one second payment device of at least one second user, wherein the first payment device and the at least one second payment device are not linked by an issuer system of the first payment device or the at least one second payment device; in response to receiving the linking request, retrieve contact data of at least one second user device of the at least one second user based on the at least one second payment device; authorize the linking request by: transmitting, using the retrieved contact data, a confirmation request to the at least one second user device; and receiving, from the at least one second user device, a confirmation response comprising a data field containing an indicator based on approving the confirmation request; in response to receiving the confirmation response containing the indicator, generate a linking identifier; store the first payment device and the at least one second payment device in a database in association with the linking identifier; receive a transaction request for a payment transaction, the transaction request identifying at least one of the first payment device and the at least one second payment device; and in response to determining that the transaction request identifies at least one of the first payment device and the at least one second payment device, invoke a linking protocol by storing transaction data associated with processing the payment transaction in the database in association with the linking identifier.

Clause 24: The computer program product of clause 23, wherein the first payment device is associated with a first account number, and the at least one second payment device is associated with at least one second account number different from the first account number.

Clause 25: The computer program product of clause 23 or 24, wherein the first payment device is issued by a first issuer system, and the at least one second payment device is issued by at least one second issuer system different from the first issuer system.

Clause 26: The computer program product of any of clauses 23-25, wherein the program instructions further cause the at least one transaction processing server to: in response to determining that the transaction request identifies at least one of the first payment device and the at least one second payment device, retrieve the linking identifier; generate an authorization request comprising data fields containing transaction data associated with the payment transaction and the linking identifier; and transmit the authorization request to the issuer system of the first payment device or the at least one second payment device to cause the issuer system to generate an authorization decision.

Clause 27: The computer program product of any of clauses 23-26, wherein the linking identifier is retrieved in real time relative to receiving the transaction request.

Clause 28: The computer program product of any of clauses 23-27, comprising a first plurality of payment transactions initiated with the first payment device and a second plurality of payment transactions initiated with the at least one second payment device, wherein the program instructions further cause the at least one transaction processing server to: invoke the linking protocol by storing transaction data associated with the first plurality of payment transactions and the second plurality of payment transactions in the database in association with the linking identifier; and generate a composite report combining transaction activity of the first payment device and the at least one second payment device associated with the linking identifier based on the transaction data associated with the first plurality of payment transactions and the second plurality of payment transactions.

Clause 29: The computer program product of any of clauses 23-28, wherein the composite report is generated in response to receiving a report request from at least one of the first user device and the at least one second user device; and the composite report is displayed on the at least one of the first user device and the at least one second user device in response to receiving the report request.

Clause 30: The computer program product of any of clauses 23-29, comprising a first plurality of payment transactions initiated with the first payment device and a second plurality of payment transactions initiated with the at least one second payment device, wherein the program instructions further cause the at least one transaction processing server to: invoke the linking protocol by storing transaction data associated with the first plurality of payment transactions and the second plurality of payment transactions in the database in association with the linking identifier; and input the transaction data associated with the first plurality of payment transactions and the second plurality of payment transactions into a machine learning algorithm, wherein the program instructions cause the machine learning algorithm to generate a composite output combining transaction activity of the first payment device and the at least one second payment device based on the transaction data associated with the first plurality of payment transactions and the second plurality of payment transactions.

Clause 31: The computer program product of any of clauses 23-30, wherein the machine learning algorithm comprises a clustering algorithm, wherein generating the composite output comprises the machine learning algorithm: for each object in the transaction data associated with the first plurality of payment transactions and the second plurality of payment transactions, generating a vector; generating a plurality of clusters; and assigning each object to a cluster of the plurality of clusters based on the vector for each object.

Clause 32: The computer program product of any of clauses 23-31, wherein each object comprises a payment transaction of the first plurality of payment transactions and the second plurality of payment transactions, wherein the vector is generated for each payment transaction based on multi-variable transaction data corresponding to each payment transaction.

Clause 33: The computer program product of any of clauses 23-32, wherein the program instructions further cause at least one processor to: generate at least one offer associated with the linking identifier based on at least one cluster of the plurality of clusters; and transmit an offer message containing the at least one offer to at least one of the first user device and the at least one second user device.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for linking latent related payment devices, according to some non-limiting embodiments or aspects;

FIGS. 2A and 2B show schematic diagrams of linking tables, according to some non-limiting embodiments or aspects;

FIG. 3 is a schematic diagram of a system for processing a payment transaction involving a linked payment device, according to some non-limiting embodiments or aspects;

FIG. 4 is a schematic diagram of a user device including a user interface displaying selectable elements enabling a user to submit a report request for a composite report, according to some non-limiting embodiments or aspects;

FIG. 5 is a schematic diagram of a user device including a user interface displaying payment device analytics, according to some non-limiting embodiments or aspects;

FIG. 6 is a schematic diagram of a system for generating an offer based on a composite output generated by a machine learning algorithm, according to some non-limiting embodiments or aspects;

FIGS. 7A and 7B are graphs generated by a machine learning algorithm based on transaction data, according to some non-limiting embodiments or aspects;

FIG. 8 is a step diagram of a method for linking latent related payment devices, according to some non-limiting embodiments or aspects; and

FIG. 9 illustrates example components of a device used in connection with non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more primary account numbers (PAN), tokens, or other identifiers associated with a customer account. For example, account identifiers in Real Time Payment (RTP) transactions may include identifiers for sender accounts (called debtor accounts) and identifiers for receiver accounts (called creditor accounts). Account identifiers may be alphanumeric or any combination of characters and/or symbols. Tokens may be associated with a PAN, debtor account identifier, creditor account identifier, or other original account identifier in one or more data structures (e.g., one or more databases, and/or the like) such that they may be used to conduct a transaction without directly using the original account identifier. In some examples, an original account identifier may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” or “user device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server computer, or other form of non-mobile computer.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a PAN, to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, and/or the like. The payment device may include a volatile or a non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

The term “processor,” as used herein, may represent any type of processing unit, such as a single processor having one or more cores, one or more cores of one or more processors, multiple processors each having one or more cores, and/or other arrangements and combinations of processing units. Reference to “at least one processor” can refer to a previously-recited processor or a different processor.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices such as, but not limited to, processors, servers, client devices, software applications, and/or other like components.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects described herein relate to systems, methods, and computer program products for linking latent, related payment devices. As used herein, “latent, related” may refer to payment devices which the users desire to relate (e.g., link) to one another, but are not yet linked, such that their relationship is not known to the issuer system. Non-limiting embodiments or aspects may link payment devices that have not been linked by an issuer system or other system processing payment transactions of those payment devices. The payment devices may be linked by receiving a linking request from a user device, which linking request identifies the unlinked payment devices requested to be linked. The user devices associated with the payment devices in the linking request may independently authorize the linking request to prevent undesired or fraudulent linking of the payment devices. To link the unlinked payment devices, a unique linking identifier may be generated and associated with each payment device in the linking request that has been authorized. The association between the previously unlinked payment devices may be stored in a database in association with the linking identifier to link the payment devices. The linking identifier and the stored association of the previously unlinked payment devices therewith may be used to generate composite reports that reflect the transaction activity of all of the linked payment devices. Linking the payment devices as disclosed herein efficiently stores the associations between these latently-related payment devices and allows for faster generation of composite reports that reflect the transaction activity of all of the linked payment devices.

After linking of the payment devices, payment transactions including a payment device linked by a linking identifier may be identified in real time relative to receiving a transaction request initiating the payment transaction, and the linking identifier may be retrieved and passed to the issuer system in a data field of the authorization request during processing of the payment transaction. As such, non-limiting embodiments or aspects generate and associate an unconventional linking identifier with the latently related payment devices, which identifier is inserted into a new and unconventional data field of the authorization request to create a modified, unconventional authorization request message that can be communicated in the communication channels of an electronic payment processing network while providing additional data.

After linking the payment devices, composite reports may be generated that combine transaction activity of the linked payment devices. Further, the transaction data of the linked payment devices may be input into a machine learning algorithm to generate composite outputs that combine transaction activity of the linked payment devices. The generation of the unconventional linking identifier enables the system to automatically and efficiently generate composite reports and/or machine learning-generated composite outputs representing patterns and insights of the linked payment devices as a group, and conserve processing resources over systems endeavoring to form composite reports and/or outputs for unlinked payment devices.

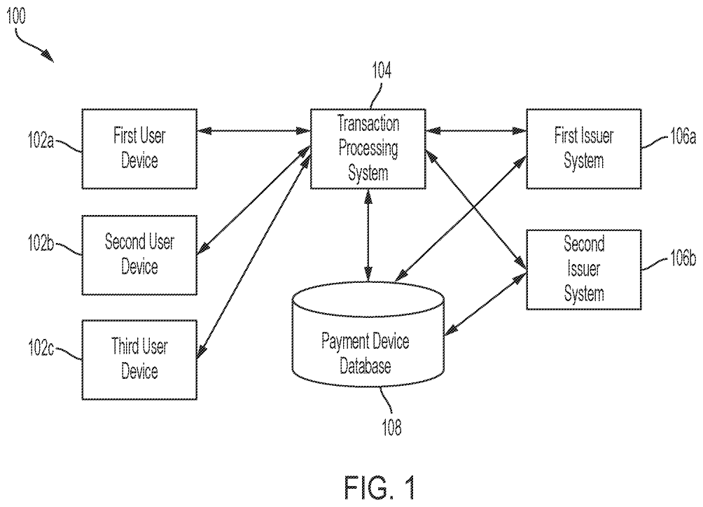

Referring to FIG. 1, a system 100 is shown for linking latent related payment devices according to some non-limiting embodiments or aspects. The system 100 may include a plurality of user devices 102a-102c, at least one transaction processing system 104, at least one issuer system 106a-106b, and at least one payment device database 108.

Each user device 102a-102c may be associated with a different user. Each user device 102a-102c may comprise a computing device of the user, such as a smartphone or other computing device of the user. Each user associated with the user devices 102a-102c may have at least one payment device issued thereto. Each payment device issued to the user may be issued to the user by at least one of the issuer systems 106a-106b. At least one transaction processing system 104 may be associated with each payment device issued to the user.

With continued reference to FIG. 1, the payment devices issued to the users by the issuer systems 106a-106b and associated with the user devices 102a-102c may be unlinked. Payment devices which are “unlinked” may refer to payment devices that are not linked as related by at least the issuer system(s) 106a-106b that issued the payment devices to the users. The issuer system(s) 106a-106b may not have data stored in a database that relates (e.g., associates) these unlinked payment devices to each other. The payment devices may be not be linked as related by other entities that process payment transactions of the payment devices, such as the transaction processing system 104, a merchant system, an acquirer system, and the like. As such, the issuer system(s) 106a-106b and other entities processing payment transactions initiated with these unlinked payment devices may be unaware of a latent relationship between the unlinked payment devices. The unlinked payment devices may have at least one different account number, such as different PANs or other unique account number or identifier assigned to user accounts, such that the accounts are not linked as related.

The unlinked payment devices may be related to one another (although initially unlinked) for belonging to the same individual or belonging to a group of individuals that associate as a group. For example, a single individual may hold multiple payment devices which are not linked, and the individual may desire to link these unlinked payment devices according to the present disclosure. For example, a group may contain a plurality of individuals, and each individual may hold at least one payment device not linked to payment devices held by other individuals of the group. Non-limiting examples of groups that may wish to associate (and may desire to link their unlinked payment devices according to the present disclosure) include, but are not limited to families having a plurality of family members, groups of friends, businesses having a plurality of business associates, organizations having a plurality of members, and the like. It will be appreciated that any group of individuals, regardless of how large, small, traditional, non-traditional, random, arbitrary, or the like, may voluntarily associate as a group and desire to have their unlinked payment devices linked according to the present disclosure.

With continued reference to FIG. 1, the system 100 may comprise the payment device database 108. The payment device database 108 may store any data associated with the payment devices issued to the users. For example, the payment device database 108 may store user data associated with the users of the payment device, such as name, date of birth, residential address, contact information, social security number or other government-issued identifier, a unique user identifier, user device identifier, and the like. The payment device database 108 may store account data associated with the account associated with the payment device, such as the PAN, expiration date, cvv code, account number, issuer identifier, cardholder data (e.g., such as the user data), and the like. The payment device database 108 may store historical transaction data associated with historical payment transactions in which the payment device has engaged, such as transaction date/time, transaction amount, merchant data (e.g., merchant identifier, merchant category code, and the like), goods/services purchased, other data fields used to process the electronic payment transactions, and the like. The payment device database 108 may store linking data (e.g., linking identifiers to link payment devices), as described hereinafter. It will be appreciated that the types of data described herein are exemplary only and any other relevant type of data may be stored in the payment device database 108. Moreover, while the payment device database 108 is illustrated in FIG. 1 as a single database, it will be appreciated that the payment device database 108 may be a single database or a plurality of databases. In some non-limiting embodiments, the payment device database 108 may be operated by or on behalf of at least one of the transaction processing system 104 and/or the issuer system(s) 106a-106b.

With continued reference to FIG. 1, to link latent related payment devices (initially unlinked), the first user device 102a may generate a linking request. In this non-limiting example of FIG. 1, the linking involves linking payment devices of users associated with the first user device 102a, second user device 102b, and third user device 102c (first, second, and third users, respectively). The linking request generated by the first user device 102a may contain data fields comprising data identifying the first payment device of the first user, the second payment device of the second user, and the third payment device of the third user. The first user device 102a may transmit the linking request to the transaction processing system 104, which receives the linking request.

In response to receiving the linking request, the transaction processing system 104 may identify the users associated with the second and third payment devices identified in the linking request. The transaction processing system 104 may identify the users associated with the second and third payment devices by querying the payment device database 108 which contains data associating the payment devices with the identity of the corresponding users.

In some non-limiting embodiment or aspects, the linking request may not comprise contact data associated with the second and third users, such that the transaction processing system 104 may retrieve contact data of the second and third users in response to receiving the linking request. The payment device database 108 may have data associating the payment devices with their corresponding user and contact data. The contact data may comprise an email address, a phone number, or any other type of data enabling communication with the second user device 102b and the third user device 102c. The transaction processing system 104 may independently retrieve contact data associated with the second and third user device, instead of receiving the contact data through the linking request from the first user device 102a, to reduce or eliminate the potential for fraudulent linking of the payment devices, such as by the linking request containing contact data not associated with the second and third user but instead associated with the first user or other user.

With continued reference to FIG. 1, the transaction processing system 104 may authorize the linking request. The linking request may be authorized by the transaction processing system 104 generating and transmitting a confirmation request to each user device associated with a payment device contained in the linking request. For example, the transaction processing system 104 may generate and transmit a first confirmation request to the second user device 102b and a second confirmation request to the third user device 102c.

In response to receiving the confirmation request, the second and third user devices 102b, 102c may generate and transmit a confirmation response, which may be received by the transaction processing system 104 to authorize the linking request. The confirmation response may comprise a data field containing an indicator based on the second and third user approving the confirmation request (and thus the linking request). The confirmation response may comprise a data field containing a different indicator or lacking the previously-described indicator based on the second and/or third user rejecting the confirmation request (and thus the linking request). The second and third user devices 102b, 102c may display at least one selectable option that may be engaged by the second and third users to indicate whether the confirmation request is to be approved or rejected, and the confirmation response may be generated and transmitted in response to the user engaging with the corresponding selectable option.

In some non-limiting embodiments or aspects, all users receiving the confirmation request (e.g., the second and third user) may approve the confirmation request, and the payment devices in the linking request may be linked as described in this disclosure in response to receiving the confirmation responses containing the approvals.

In some non-limiting embodiments or aspects, all users receiving the confirmation request (e.g., the second and third user) may reject the confirmation request, and termination of the linking request (without linking the payment devices) may occur in response to receiving the confirmation responses containing the rejections.

In some non-limiting embodiments or aspects, a first subset of the users receiving the confirmation request (e.g., the second user) may approve the confirmation request, while a second subset of the users receiving the confirmation request (e.g., the third user) may reject the confirmation request. In some non-limiting embodiments, a single rejection of the confirmation request may cause termination of the entire linking request (without linking any of the payment devices) in response to receiving the confirmation responses. In some non-limiting embodiments, a rejection of the confirmation request from the second subset of users may cause termination of only a portion of the linking request (e.g., the portion associated with the rejecting second subset of users), while the payment devices corresponding to the authorization approvals from the first subset of users may still be linked.

With continued reference to FIG. 1, in response to receiving the confirmation responses containing the indicator approving the confirmation request, the linking of the approved payment devices may be executed by generating a linking identifier for the group of payment devices. The linking identifier may be any identifier, such as a numeric or alphanumeric identifier, which uniquely identifies the group of payment devices being linked together. The transaction processing system 104 may generate the linking identifier.

The transaction processing system 104 may store the linking identifier in the payment device database 108 in association with the payment devices identified in the linking request that were approved for linking. For example, if the first user device 102a, the second user device 102b, and the third user device 102c all approved the linking of the first, second, and third payment devices, each of the first, second, and third payment devices may be associated with the generated linking identifier and the association therebetween (e.g., with a database pointer, graph, table, and/or the like) may be stored in the payment device database 108.

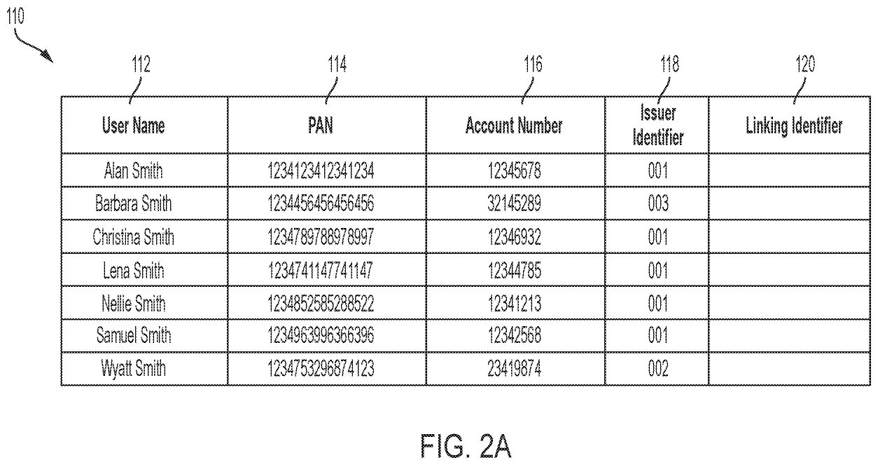

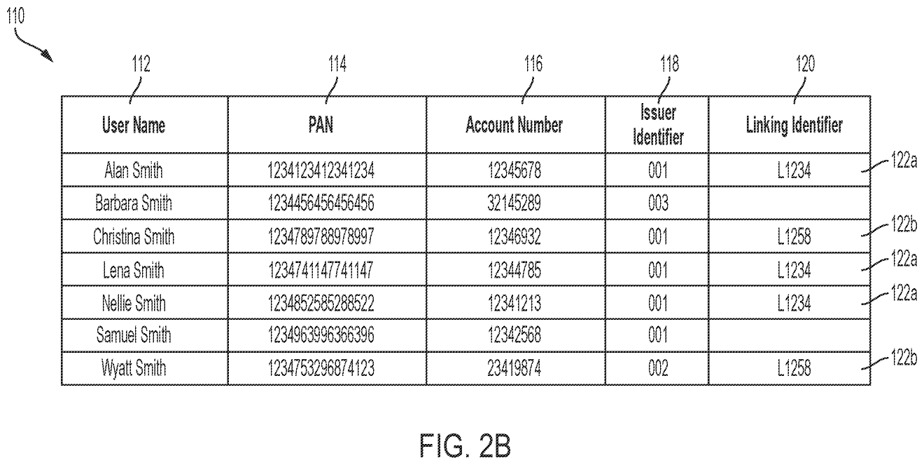

Referring to FIGS. 2A and 2B, linking tables 110 are shown according to some non-limiting embodiments or aspects. FIG. 2A shows a linking table 110 which may be stored in the payment device database 108 (not shown), and the linking table 110 in FIG. 2A may illustrate a non-limiting example of payment devices stored in the linking table 110 that are not linked to one another. The linking table 110 may include fields containing data associated with payment devices of users, such as: a user name field 112, a PAN field 114, an account number field 116, an issuer identifier field 118, and a linking identifier field 120, although it will be appreciated that more or fewer fields may be included in the linking table 110. The linking table 110 may be in the form of any type of data structure, such as a graph, multidimensional array, and/or the like.

FIG. 2B illustrates a non-limiting example of data associated with payment devices stored in the linking table 110, wherein the payment devices are now linked to one another. The linking table 110 from Table 2A is identical to the linking table 110 from FIG. 2B except for FIG. 2B containing links 122a-122b in the linking identifier field 120 to link certain payment devices that were previously unlinked but were latently related to one another. In the non-limiting example of FIG. 2B, the payment devices for Alan Smith, Lena Smith, and Nellie Smith, are linked together by link 122a (L1234) stored in each linking identifier field 120 for these 3 individuals. In the non-limiting example of FIG. 2B, the payment devices for Christina Smith and Wyatt Smith, are linked together by link 122b (L1258) stored in each linking identifier field 120 for these 3 individuals. The links 122a-122b not included in the linking table 110 from FIG. 2A may be generated, stored, and associated as previously described to form the linking table 110 from FIG. 2B.

With continued reference to FIG. 2B and link 122a, in some non-limiting embodiments or aspects, the linked payment devices may be issued to the different users by the same issuer system (e.g., the issuer system corresponding to issuer identifier 001). Referring to link 122b, in some non-limiting embodiments or aspects, the linked payment devices may be issued to the different users by the different issuer system (e.g., the issuer system corresponding to issuer identifiers 001 and 002).

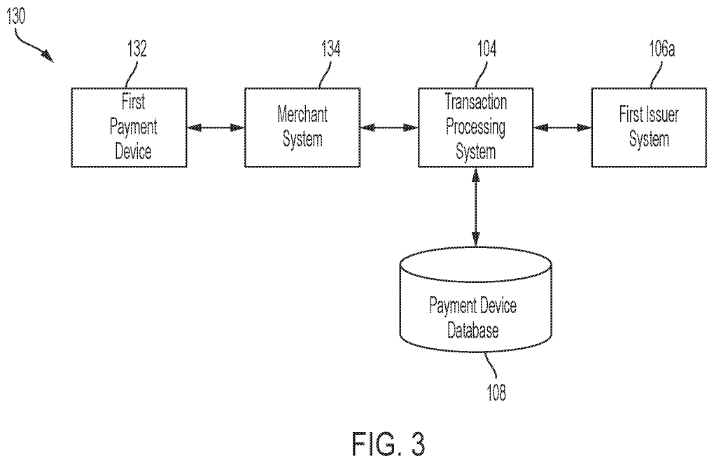

Referring to FIG. 3, a system 130 is shown for processing a payment transaction involving a linked payment device according to some non-limiting embodiments or aspects. The system 130 may comprise an electronic payment processing network comprising a merchant system 134, the transaction processing system 104, and the first issuer system 106a interacting to process a payment transaction initiated by a first payment device 132 of the first user. The first payment device 132 may be a payment device linked to at least one other payment device (e.g., a second payment device) according to the present disclosure. The transaction processing system 104 may correspond to the transaction service provider associated with the first payment device 132. The first issuer system 106a may correspond to the issuer that issued the first payment device 132.

With continued reference to FIG. 3, the first payment device 132 may initiate a payment transaction between the user and a merchant associated with the merchant system 134 by engaging the first payment device 132 with the merchant system 134. This may comprise initiating a payment transaction at a location of the merchant by engaging the first payment device 132 with the merchant system 134, such as engaging the first payment device 132 with a merchant POS device (not shown). This may comprise initiating a payment transaction remote from a location of the merchant by engaging the first payment device 132 with the merchant system 134, such as by initiating an e-commerce transaction.

In response to the first payment device 132 initiating the payment transaction, the merchant system 134 may generate a transaction request containing transaction data associated with the payment transaction. The transaction data may comprise data needed by the electronic payment processing network to process the payment transaction, such as the data elements specified in ISO 8583. Processing the payment transaction may comprise authorizing, clearing, and settling the payment transaction. The merchant system 134 may communicate the transaction request to the transaction processing system 104.

In response to receiving the transaction request, the transaction processing system 104 may determine whether the first payment device 132 is a linked payment device. This may be performed by the transaction processing system 104 querying the payment device database 108 based on the identification of the first payment device 132 (e.g., the PAN) contained in the transaction request. Thus, the transaction processing system 104 may determine that the first payment device 132 is linked to the second payment device.

With continued reference to FIG. 3, in response to the transaction processing system 104 determining that the first payment device 132 and the second payment device are linked, the transaction processing system 104 may automatically invoke and execute a linking protocol. The linking protocol may comprise storing transaction data associated with the processing of the payment transaction in the payment device database 108 in association with the linking identifier associated with the first payment device 132 and the second payment device. As such, even though the payment transaction was initiated by the first payment device 132, the transaction data associated therewith will also be associated in the payment device database 108 with the second payment device (and any other payment device linked to the first payment device 132) because the linking identifier links the first payment device 132 with the second payment device.

The linking protocol to store transaction data associated with the processing of the payment transaction in the payment device database 108 in association with the linking identifier associated with the first payment device 132 and the second payment device may be executed at the time the transaction request is received. However, it will be appreciated that the linking protocol may be executed at any time during or after processing of the payment transaction. For example, the linking protocol may be executed after authorization of the payment transaction or other time during or after processing at which it is more certain that the payment transaction will not be reversed, such as during or after clearing, during or after settlement, during or after delivery of the goods/services, and the like.

In response to receiving the transaction request and in response to the transaction processing system 104 determining that the first payment device 132 and the second payment device are linked, the transaction processing system may generate an authorization request containing at least a portion of the transaction data associated with the payment transaction. In response to the transaction processing system 104 determining that the first payment device 132 and the second payment device are linked, the transaction processing system 104 may also retrieve the linking identifier associated with the first payment device 132 from the payment device database 108. The linking identifier may be retrieved by the transaction processing system 104 in real time relative to receiving the transaction request, such that the linking identifier may be included in the authorization request being generated by the transaction processing system 104. The transaction processing system 104 may insert the retrieved linking identifier into a corresponding data field of the generated authorization request, such that the authorization request contains both the transaction data associated with the payment transaction and the linking identifier.

The transaction processing system 104 may transmit the authorization request to the first issuer system 106a to cause the first issuer system 106a to generate an authorization decision for the payment transaction. The authorization decision may be to authorize the transaction, decline the transaction, and/or any combination thereof. The authorization request comprising the data field containing the linking identifier may alert the first issuer system 106a that the payment transaction involves a linked payment device. In some non-limiting embodiments or aspects, the first issuer system 106a may, in response, store transaction data associated with authorization requests comprising the data field containing the linking identifier, such that composite reports as described herein may be generated by the first issuer system 106a based on the stored transaction data.

In response to receiving the authorization request, the first issuer system 106a may generate the authorization decision and generate an authorization response containing the authorization decision. The authorization decision may be based on the first issuer system 106a analyzing at least a portion of the transaction data associated with the payment transaction and contained in the authorization request. The first issuer system 106a may communicate the authorization response to the transaction processing system 104.

In response to receiving the authorization response, the transaction processing system 104 may generate a transaction response containing the authorization decision. The transaction processing system 104 may communicate the transaction response to the merchant system 134.

If the authorization decision of the issuer system 106a is to authorize the payment transaction (and/or at least partially authorize the payment transaction), the electronic payment processing network may continue processing the payment transaction to completion, which may comprise clearing and/or settling the payment transaction.

Referring to FIGS. 3-5, the system 130 may process a plurality of payment transactions initiated by the first payment device 132 and may also process a plurality of payment transactions initiated by the second payment device linked to the first payment device 132. For each of the plurality of payment transactions initiated by the first payment device 132 and the plurality of payment transactions initiated by the second payment device, the linking protocol may be invoked as previously described to store transaction data associated with each payment transaction in the payment device database 108 in association with the linking identifier of the first payment device 132 and the second payment device.

Based on the transaction data stored in the payment device database 108 in association with the linking identifier, a composite report may be automatically generated which combines the transaction history of the payment devices associated with the linking identifier (e.g., the first payment device 132 and the second payment device). The composite report may be generated based on the transaction data stored in the payment device database 108 associated with the linking identifier. The composite report may be generated to include transaction data of both the first payment device 132 and the second payment device because the payment devices are linked together in the payment device database using the linking identifier. The composite report may be generated by the transaction processing system 104, the first issuer system 106a, or any other entity.

The composite report may be generated, for example, by the transaction processing system 104 and/or the first issuer system 106a retrieving the transaction data stored in the payment device database 108 associated with the linking identifier, analyzing the retrieved transaction data, and generating the composite report.

In some non-limiting embodiments or aspects, the composite report may be automatically generated, such as daily, weekly, monthly, quarterly, yearly, and these periodic composite reports may be made accessible to the user devices associated with the linked payment devices. For example, the composite reports may be made accessible on a website portal or mobile application accessible to the user devices associated with the linked payment devices. In some non-limiting embodiments or aspects, the composite report may be automatically generated in response to the initiation, processing, and/or completion of a payment transaction initiated by one of the linked payment devices.

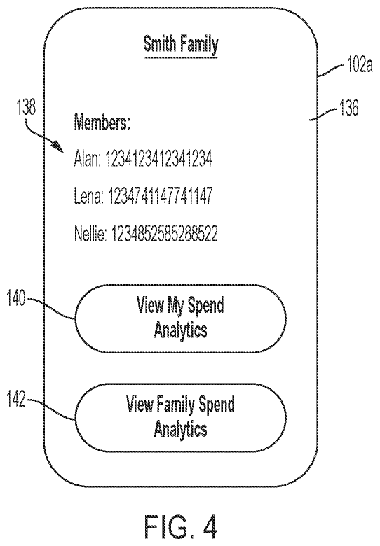

Referring to FIGS. 3 and 4, in some non-limiting embodiments or aspects, the composite report may be generated in response to receiving a report request. The report request may be transmitted, for example, from the first user device 102a of the user corresponding to the first payment device 132 (one of the linked payment devices associated with the linking identifier) to the transaction processing system 104 and/or the first issuer system 106a. The first user device 102a may display a user interface 136 associated with the linked payment devices. For example, the user interface 136 may display linked data 138 showing data associated with the users linked by the linking identifier and/or data associated with the payment devices linked by the linking identifier.

With continued reference to FIGS. 3 and 4, the user interface 136 may also display an individual analytics selectable element 140. The user of the first user device 102a may select the individual analytics selectable element 140 to cause a report to be generated that reflects the transaction activity of only the first payment device 132 (e.g., not a composite report). Selection of the individual analytics selectable element 140 may cause the first user device 102 to generate a report request containing an identifier of the first payment device 132, and the report request may be transmitted to the transaction processing system 104 and/or the first issuer system 106a. In response, the transaction processing system 104 and/or the first issuer system 106a may retrieve transaction data associated with the first payment device 132 (and not other payment devices linked to the first payment device 132) and may generate the report that reflects only the transaction activity of the first payment device 132. The report that reflects only the transaction activity of the first payment device 132 may be transmitted to the first user device 102a, and in response to receiving the report, the first user device 102a may display the report.

With continued reference to FIGS. 3 and 4, the user interface 136 may display a linked analytics selectable element 142. The user of the first user device 102a may select the linked analytics selectable element 142 to cause the composite report to be generated that reflects the transaction activity of the first payment device 132 and the second payment device (and any other payment device linked with the same linking identifier). Selection of the linked analytics selectable element 142 may cause the first user device 102 to generate the composite report request containing an identifier of the first payment device 132, the second payment device, and/or the linked identifier, and the report request may be transmitted to the transaction processing system 104 and/or the first issuer system 106a. In response, the transaction processing system 104 and/or the first issuer system 106a may retrieve transaction data associated with the linked identifier and may generate the composite report that reflects the transaction activity of all of the payment devices linked by the linked identifier. The composite report may be transmitted to the first user device 102a, and in response to receiving the composite report, the first user device 102a may display the composite report.

In some non-limiting embodiment or aspects, the report request or the composite report request may be transmitted, for example, from the first issuer system 106a to the transaction processing system 104.

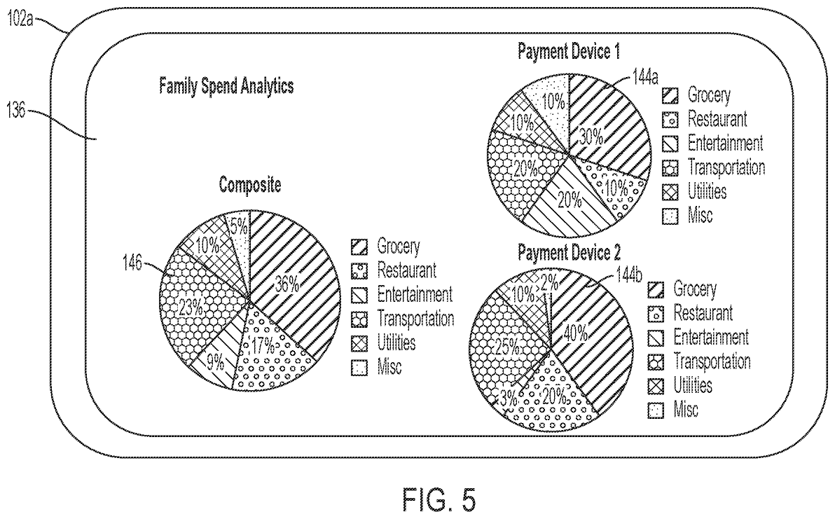

Referring to FIG. 5, the first user device 102a is shown including the user interface 136 displaying payment device analytics. The payment device analytics may comprise individual device analytics 144a, 144b derived from transaction data of a single payment device and reflecting transaction activity of that single payment device. The individual device analytics 144a, 144b may be displayed on the user interface 136 in response to receiving the report that reflects only the transaction activity of the single payment device. In the non-limiting example of FIG. 5, individual device analytics 144a are displayed associated with the first payment device 132, and separate individual device analytics 144b are displayed associated with the second payment device, such that the individual device analytics 144a, 144b of the linked payment devices may be individually displayed.

With continued reference to FIG. 5, the first user device 102a is shown including the user interface 136 displaying payment device analytics. The payment device analytics may comprise linked device analytics 146 derived from the transaction data of all of the linked payment devices and reflecting composite transaction activity of all of the linked payment devices. The linked device analytics 146 may be displayed on the user interface 136 in response to receiving the composite report.

The analytics displayed as the individual device analytics 144a, 144b and/or the linked device analytics 146 may comprise any data derivable from the transaction data associated with the payment device(s). For example, the analytics may comprise a list of transactions initiated by the payment device(s), an aggregate amount spent using the payment device(s), a categorical breakdown of the transactions initiated by the payment device(s) (e.g., by merchant category code or other categorization of goods/services purchased), and the like. In the non-limiting example from FIG. 5, the individual device analytics 144a, 144b and/or the linked device analytics 146 show the percentage spent by the payment device(s) on a plurality of different categories of goods/services (e.g., grocery, restaurant, entertainment, transportation, utilities, miscellaneous). The individual device analytics 144a, 144b and/or the linked device analytics 146 may display the analytics of the payment device(s) over a predetermined time period, such as a predetermined day, week, month, quarter, year, or the like.

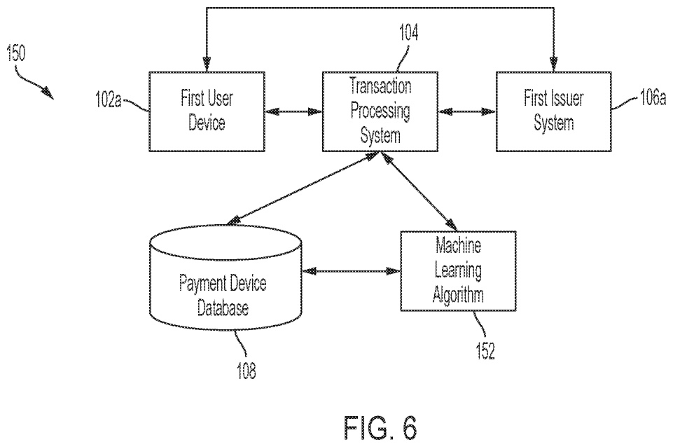

Referring to FIG. 6, a system 150 is shown for generating an offer based on a composite output generated by a machine learning algorithm 152 according to some non-limiting embodiments or aspects. The machine learning algorithm 152 may be trained using historical transaction data, and may be re-trained continually and/or periodically as additional transaction data is received. Non-limiting examples of historical transaction data parameters that may be used to train the machine learning algorithm 152 include transaction counts, transaction amounts, merchant category codes, issuer names, issuer locations, merchant locations, and the like.

As previously described, for each of the plurality of payment transactions initiated by the first payment device 132 (not shown) and the plurality of payment transactions initiated by the second payment device, the linking protocol may be invoked to store transaction data associated with each payment transaction in the payment device database 108 in association with the linking identifier of the first payment device 132 and the second payment device.

The transaction data stored in the payment device database 108 in association with the linking identifier may be input to the machine learning algorithm 152. In response to receiving the input, the machine learning algorithm 152 may automatically generate a composite output combining transaction activity of the linked payment devices (e.g., the first payment device 132 and the second payment device) based on the transaction data in the input. As used herein “composite output” may refer to the output of the machine learning algorithm 152 being derived from transaction data associated with a plurality of the linked payment devices, as opposed to the output being derived from transaction data of only a single payment device. The transaction data may comprise any of the transaction data previously described herein. Non-limiting examples of transaction data that may be input to the machine learning algorithm 152 may comprise merchant category code, transaction type (e.g., purchase of goods/services, cash withdrawal, deferred transaction, and the like), cardholder present indicator, card present indicator, postal code (e.g., cardholder location), aggregate spending, and the like.

The composite output may be any machine learning-generated output based on the transaction data input to the machine learning algorithm 152, and the output may represent analyses derived from the transaction activity of the plurality of linked payment devices (as opposed to only a single payment device). As non-limiting examples, the composite output may comprise at least one of a prediction, a score, a label, a classification, and/or the like generated for payment transactions initiated by the linked payment devices. For example, the machine learning algorithm 152 may generate clusters and associate each payment transaction with at least one cluster based on vectors generated for the payment transactions, such that the output may comprise a prediction, a score, a label, a classification, or the like based on the cluster with which the payment transaction is associated.

In some non-limiting embodiments or aspects, the machine learning algorithm 152 may execute a clustering algorithm to generate the composite output. The composite output may be generated using the clustering algorithm by the machine learning algorithm 152 generating a vector for each object in the transaction data associated with the linked payment devices. The vector may be represented by coordinates in a multi-dimensional space. The machine learning algorithm 152 may generate a plurality of clusters. The number of clusters may be generated using any suitable machine learning technique, such as k-means clustering, mean-shift clustering, density-based spatial clustering of applications with noise (DBSCAN), expectation maximization (EM) clustering using Gaussian mixture models (GMM), agglomerative hierarchical clustering, and the like. The machine learning algorithm 152 may comprise an unsupervised machine learning clustering technique. Each object may be assigned to a cluster of the plurality of clusters based on the vector generated for each object.

As a non-limiting example, each object (e.g., node) may comprise a single payment transaction from the linked payment devices. The vector may be generated for each payment transaction based on multi-variable transaction data corresponding to that specific payment transaction. The multi-variable transaction data may comprise any data associated with the payment transaction, such as any data used to process the payment transaction (e.g., transaction value, transaction time, transaction type, and/or the like). Clustering the payment transactions in this way may quantify the similarity between payment transactions and cluster similar payment transactions together. In some non-limiting embodiments or aspects, clustering may quantify the similarity between linked groups of payment devices (as opposed to individual payment devices) so that the clustering analysis may identify similar linked groups (e.g., linked groups having similar spending patterns).

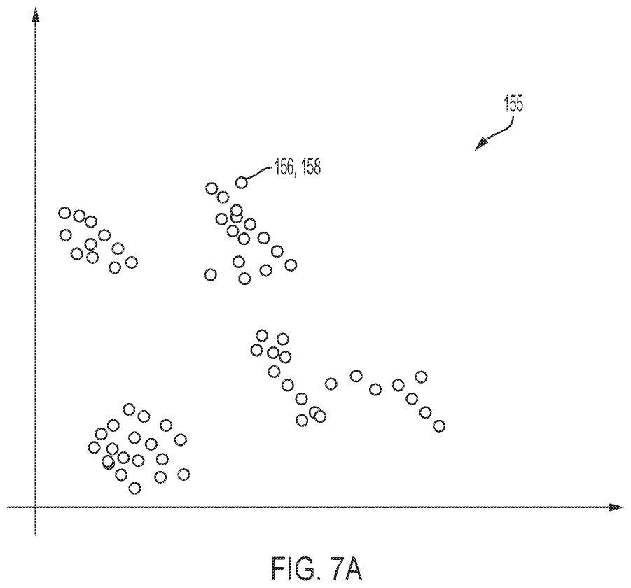

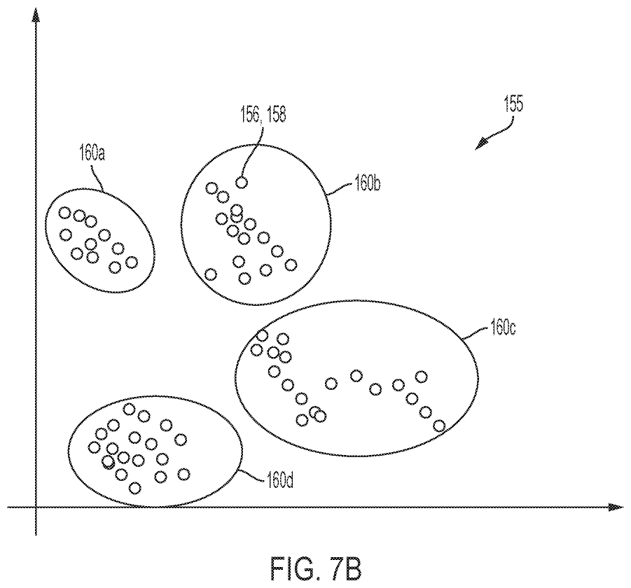

Referring to FIGS. 7A and 7B, graphs 155 are shown which may be generated by the machine learning algorithm 152 (not shown) based on transaction data from linked payment devices according to some non-limiting embodiments or aspects. In FIG. 7A, the graph 155 comprises a plurality of objects 156 represented as vectors 158. While the graph 155 shows a two-dimensional space, it will be appreciated that the vectors 158 may be graphically represented in an n-dimensional space, and n may be any number greater than or equal to 2. The graph 155 in FIG. 7A shows the objects 156 represented as vectors 158 before clustering. FIG. 7B shows the same graph 155 from FIG. 7A except the machine learning algorithm 152 has generated a plurality of clusters 160a-160d as shown in the graph. In FIG. 7B, each object 156 (e.g., payment transaction, linked group of payment devices, and the like) is shown assigned to at least one of the clusters 160a-160d. Objects 156 in the same cluster 160b may represent objects 156 the machine learning algorithm 152 has determined to be similar, for example based on the multi-dimensional transaction data of the linked payment devices.

Referring again to FIG. 6, the machine learning algorithm 152 may transmit the composite output to the transaction processing system 104. In some non-limiting embodiments or aspects, the machine learning algorithm 152 may transmit the composite output to the to the first issuer system 106a. The composite output may also be stored in the payment device database 108 associated with the linking identifier.

With continued reference to FIG. 6, in response to receiving the composite output, the transaction processing system 104 (and/or the first issuer system 106a) may generate at least one offer associated with the linking identifier. In some non-limiting embodiments, the machine learning algorithm 152 may generate the at least one offer based on the composite output. The offer may be generated based on indications from the composite output as to what types of offers may be suitable for the linked payment devices. For example, the offer may be generated based on at least one cluster generated by the machine learning algorithm. For example, a characteristic associated with a generated cluster may indicate a type of offer suitable for the linked payment devices. The characteristic may comprise at least one parameter of the transaction data that is similar among all objects in a given cluster.

Non-limiting examples of offers that may be generated include an invitation to a reward program, an invitation to apply for a new payment device, a discount for using the payment device, an offer for a financial device other than a payment device (e.g., a loan, insurance policy, and the like), a discount or reward for a target merchant, product/service, category of goods/services, and the like.

With continued reference to FIG. 6, an offer message containing the offer may be generated and transmitted to the first user device 102a and/or any other user device associated with a payment device linked by the linking identifier. The offer message may be transmitted to all of the user devices associated with the linked payment devices or to only a subset of the user devices associated with the linked payment devices. The offer message maybe transmitted to the first user device 102a by email, text message, push notification to the mobile application, push notification to the web browser account portal, or any other suitable communication technique. The offer may be displayed for the user on the first user device 102a in response to receiving the offer message.

The user may engage with a selectable element on the first user device 102a to accept or decline the offer. In response to the user engaging the selectable element to accept or decline the offer, an offer response message may be generated by the first user device 102a that comprises a data field containing an indicator as to whether the offer was accepted or declined. The offer response message may be communicated to the transaction processing system 104 and/or the first issuer system 106a. In response to receiving the offer response message containing an acceptance indicator, the transaction processing system 104 and/or the first issuer system 106a may initiate implementation of the offer.

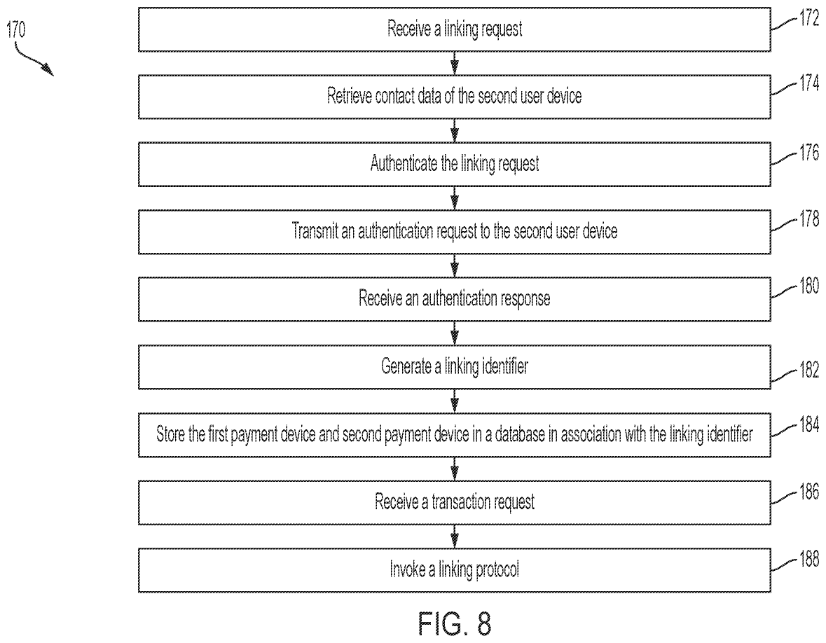

Referring to FIG. 8, a computer-implemented method 170 is shown for linking latent related payment devices according to some non-limiting embodiments or aspects. At a step 172, the computer-implemented method 170 may include receiving, with the transaction processing server, a linking request from a first user device of a first user, the linking request identifying a first payment device of the first user and at least one second payment device of at least one second user, wherein the first payment device and the at least one second payment device are not linked by an issuer system of the first payment device or the at least one second payment device.

At a step 174, the computer-implemented method 170 may include, in response to receiving the linking request, retrieving, with the transaction processing server, contact data of at least one second user device of the at least one second user based on the at least one second payment device.

At a step 176, the computer-implemented method 170 may include authorizing, with the transaction processing server, the linking request by: at a step 178, transmitting, using the retrieved contact data, a confirmation request to the at least one second user device; and at a step 180, receiving, from the at least one second user device, a confirmation response comprising a data field containing an indicator based on approving the confirmation request.

At a step 182, the computer-implemented method 170 may include, in response to receiving the confirmation response containing the indicator, generating, with the transaction processing server, a linking identifier.

At a step 184, the computer-implemented method 170 may include storing, with the transaction processing server, the first payment device and the at least one second payment device in a database in association with the linking identifier.

At a step 186, the computer-implemented method 170 may include receiving, with the transaction processing server, a transaction request for a payment transaction, the transaction request identifying at least one of the first payment device and the at least one second payment device.

At a step 188, the computer-implemented method 170 may include, in response to determining that the transaction request identifies at least one of the first payment device and the at least one second payment device, invoking, with the transaction processing server, a linking protocol by storing transaction data associated with processing the payment transaction in the database in association with the linking identifier.

In some non-limiting embodiment or aspects, a computer program product for linking latent related payment devices includes at least one non-transitory computer readable medium including program instructions that, when executed by at least one processor, cause the at least one processor to execute one of the previously-described methods. The at least one processor may include any of the components shown in FIGS. 1 and 3-6 (e.g., the user devices 102a-102c, transaction processing system 104, issuer systems 106a-106b, payment device database 108, first payment device 132, merchant system 134, machine learning algorithm 152, and the like).

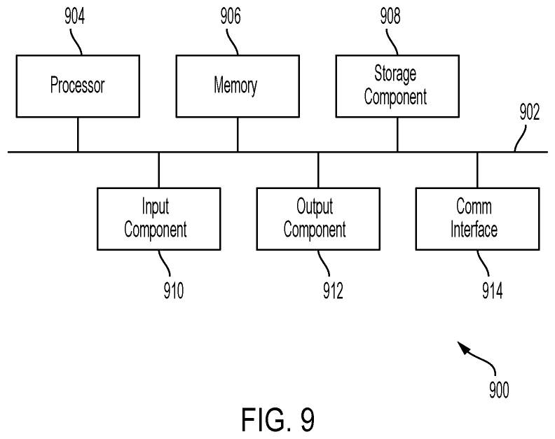

Referring to FIG. 9, shown is a diagram of example components of a device 900 according to non-limiting embodiments or aspects. Device 900 may correspond to any of the user devices 102a-102c, transaction processing system 104, issuer systems 106a-106b, payment device database 108, first payment device 132, merchant system 134, and machine learning algorithm 152 shown in FIGS. 1 and 3-6, as an example. In some non-limiting embodiments or aspects, such systems or devices may include at least one device 900 and/or at least one component of device 900. The number and arrangement of components shown are provided as an example. In some non-limiting embodiments or aspects, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
receiving, with a transaction processing server, a linking request from a first user device of a first user, the linking request identifying a first payment device of the first user and at least one second payment device of at least one second user, wherein the first payment device and the at least one second payment device are not linked by an issuer system of the first payment device or the at least one second payment device;
in response to receiving the linking request, retrieving, with the transaction processing server, contact data of at least one second user device of the at least one second user based on the at least one second payment device;
authorizing, with the transaction processing server, the linking request by:
transmitting, using the retrieved contact data, a confirmation request to the at least one second user device; and
receiving, from the at least one second user device, a confirmation response comprising a data field containing an indicator based on approving the confirmation request;
in response to receiving the confirmation response containing the indicator, generating, with the transaction processing server, a linking identifier;
storing, with the transaction processing server, the first payment device and the at least one second payment device in a database in association with the linking identifier;
receiving, with the transaction processing server, a transaction request for a payment transaction, the transaction request identifying at least one of the first payment device and the at least one second payment device; and
in response to determining that the transaction request identifies at least one of the first payment device and the at least one second payment device, invoking, with the transaction processing server, a linking protocol by storing transaction data associated with processing the payment transaction in the database in association with the linking identifier.

2. The computer-implemented method of claim 1, wherein the first payment device is associated with a first account number, and the at least one second payment device is associated with at least one second account number different from the first account number.

3. The computer-implemented method of claim 1, wherein the first payment device is issued by a first issuer system, and the at least one second payment device is issued by at least one second issuer system different from the first issuer system.

4. The computer-implemented method of claim 1, further comprising:
in response to determining that the transaction request identifies at least one of the first payment device and the at least one second payment device, retrieving, with the transaction processing server, the linking identifier;
generating, with the transaction processing server, an authorization request comprising data fields containing transaction data associated with the payment transaction and the linking identifier; and
transmitting, with the transaction processing server, the authorization request to the issuer system of the first payment device or the at least one second payment device to cause the issuer system to generate an authorization decision.

5. The computer-implemented method of claim 4, wherein the linking identifier is retrieved in real time relative to receiving the transaction request.

6. The computer-implemented method of claim 1, comprising a first plurality of payment transactions initiated with the first payment device and a second plurality of payment transactions initiated with the at least one second payment device, the computer-implemented method further comprising:
invoking, with the transaction processing server, the linking protocol by storing transaction data associated with the first plurality of payment transactions and the second plurality of payment transactions in the database in association with the linking identifier; and
generating, with the transaction processing server, a composite report combining transaction activity of the first payment device and the at least one second payment device associated with the linking identifier based on the transaction data associated with the first plurality of payment transactions and the second plurality of payment transactions.

7. The computer-implemented method of claim 6, wherein the composite report is generated in response to receiving a report request from at least one of the first user device and the at least one second user device; and
the composite report is displayed on the at least one of the first user device and the at least one second user device in response to receiving the report request.

8. The computer-implemented method of claim 1, comprising a first plurality of payment transactions initiated with the first payment device and a second plurality of payment transactions initiated with the at least one second payment device, the computer-implemented method further comprising:
invoking, with the transaction processing server, the linking protocol by storing transaction data associated with the first plurality of payment transactions and the second plurality of payment transactions in the database in association with the linking identifier;
inputting, with the transaction processing server, the transaction data associated with the first plurality of payment transactions and the second plurality of payment transactions into a machine learning algorithm; and
generating, with the machine learning algorithm, a composite output combining transaction activity of the first payment device and the at least one second payment device based on the transaction data associated with the first plurality of payment transactions and the second plurality of payment transactions.

9. The computer-implemented method of claim 8, wherein the machine learning algorithm comprises a clustering algorithm, wherein generating the composite output comprises the machine learning algorithm:
for each object in the transaction data associated with the first plurality of payment transactions and the second plurality of payment transactions, generating a vector;
generating a plurality of clusters; and
assigning each object to a cluster of the plurality of clusters based on the vector for each object.

10. The computer-implemented method of claim 9, wherein each object comprises a payment transaction of the first plurality of payment transactions and the second plurality of payment transactions, wherein the vector is generated for each payment transaction based on multi-variable transaction data corresponding to each payment transaction.

11. The computer-implemented method of claim 9, further comprising:
generating at least one offer associated with the linking identifier based on at least one cluster of the plurality of clusters; and
transmitting an offer message containing the at least one offer to at least one of the first user device and the at least one second user device.

12. A system comprising at least one transaction processing server, programmed or configured to:
receive a linking request from a first user device of a first user, the linking request identifying a first payment device of the first user and at least one second payment device of at least one second user, wherein the first payment device and the at least one second payment device are not linked by an issuer system of the first payment device or the at least one second payment device;
in response to receiving the linking request, retrieve contact data of at least one second user device of the at least one second user based on the at least one second payment device;
authorize the linking request by:
transmitting, using the retrieved contact data, a confirmation request to the at least one second user device; and
receiving, from the at least one second user device, a confirmation response comprising a data field containing an indicator based on approving the confirmation request;
in response to receiving the confirmation response containing the indicator, generate a linking identifier;
store the first payment device and the at least one second payment device in a database in association with the linking identifier;
receive a transaction request for a payment transaction, the transaction request identifying at least one of the first payment device and the at least one second payment device; and
in response to determining that the transaction request identifies at least one of the first payment device and the at least one second payment device, invoke a linking protocol by storing transaction data associated with processing the payment transaction in the database in association with the linking identifier.

13. The system of claim 12, wherein the first payment device is associated with a first account number, and the at least one second payment device is associated with at least one second account number different from the first account number.

14. The system of claim 12, wherein the first payment device is issued by a first issuer system, and the at least one second payment device is issued by at least one second issuer system different from the first issuer system.

15. The system of claim 12, wherein the at least one transaction processing server is further programmed or configured to:
in response to determining that the transaction request identifies at least one of the first payment device and the at least one second payment device, retrieve the linking identifier;
generate an authorization request comprising data fields containing transaction data associated with the payment transaction and the linking identifier; and
transmit the authorization request to the issuer system of the first payment device or the at least one second payment device to cause the issuer system to generate an authorization decision.

16. The system of claim 15, wherein the linking identifier is retrieved in real time relative to receiving the transaction request.

17. The system of claim 12, comprising a first plurality of payment transactions initiated with the first payment device and a second plurality of payment transactions initiated with the at least one second payment device, wherein the at least one transaction processing server is further programmed or configured to:
invoke the linking protocol by storing transaction data associated with the first plurality of payment transactions and the second plurality of payment transactions in the database in association with the linking identifier; and
generate a composite report combining transaction activity of the first payment device and the at least one second payment device associated with the linking identifier based on the transaction data associated with the first plurality of payment transactions and the second plurality of payment transactions.

18. The system of claim 17, wherein the composite report is generated in response to receiving a report request from at least one of the first user device and the at least one second user device; and
the composite report is displayed on the at least one of the first user device and the at least one second user device in response to receiving the report request.

19. The system of claim 12, comprising a first plurality of payment transactions initiated with the first payment device and a second plurality of payment transactions initiated with the at least one second payment device, wherein the at least one transaction processing server is further programmed or configured to:
invoke the linking protocol by storing transaction data associated with the first plurality of payment transactions and the second plurality of payment transactions in the database in association with the linking identifier; and
input the transaction data associated with the first plurality of payment transactions and the second plurality of payment transactions into a machine learning algorithm,
wherein the system comprises the machine learning algorithm programmed or configured to generate a composite output combining transaction activity of the first payment device and the at least one second payment device based on the transaction data associated with the first plurality of payment transactions and the second plurality of payment transactions.

20. A computer program product comprising at least one non-transitory computer-readable medium including program instructions that, when executed by at least one transaction processing server, cause the at least one transaction processing server to:
receive a linking request from a first user device of a first user, the linking request identifying a first payment device of the first user and at least one second payment device of at least one second user, wherein the first payment device and the at least one second payment device are not linked by an issuer system of the first payment device or the at least one second payment device;
in response to receiving the linking request, retrieve contact data of at least one second user device of the at least one second user based on the at least one second payment device;
authorize the linking request by:
transmitting, using the retrieved contact data, a confirmation request to the at least one second user device; and
receiving, from the at least one second user device, a confirmation response comprising a data field containing an indicator based on approving the confirmation request;
in response to receiving the confirmation response containing the indicator, generate a linking identifier;
store the first payment device and the at least one second payment device in a database in association with the linking identifier;
receive a transaction request for a payment transaction, the transaction request identifying at least one of the first payment device and the at least one second payment device; and
in response to determining that the transaction request identifies at least one of the first payment device and the at least one second payment device, invoke a linking protocol by storing transaction data associated with processing the payment transaction in the database in association with the linking identifier.
